(19) United States
(12) Patent Application Publication
(10) Pub. No.: US 2011/0015550 A1
(43) Pub. Date: Jan. 20, 2011

(54) Exercise aiding apparatus

(75) Inventors: Youichi Shinomiya, Ibaraki-shi (JP); Takahisa Ozawa, Katano-shi (JP); Takao Gotou, Hirakata-shi (JP); Kazuhiro Ochi, Osaka-shi (JP); Naoto Shirasawa, Kyoto-shi (JP); Masaki Nagano, Ibaraki-shi (JP)

Correspondence Address: EDWARDS ANGELL PALMER & DODGE LLP, P.O. BOX 55874, BOSTON, MA, 02205, US

(73) Assignee: Panasonic Electric Works Co., Ltd., Kadoma-shi (JP)

(21) Appl. No.: 12/736,287

(22) PCT Filed: Mar. 31, 2008
(86) PCT No.: PCT/JP2008/056439

§ 371 Date: Sep. 27, 2010

(51) Int. Cl. A61H 1/02

(52) U.S. Cl. 601/5

(57) ABSTRACT

An exercise aiding apparatus has: a step (2) on which user's foot can be placed; a step driving means (5) for causing the step (2) to move, and causing thereby the foot placed on the step to exercise; and a motion allowable zone modifying means for expanding a motion allowable range of the steps (2) established by the step driving means in accordance with a load acting on the step (2). The motion allowable range of the step (2) is expanded when the user intentionally increases the load acting on the step (2).

### TECHNICAL FIELD

The present invention relates to an exercise aiding apparatus that promotes exercise of a user's legs, and more particularly, to an exercise aiding apparatus that imparts passive exercise to the legs.

### BACKGROUND ART

Various exercise aiding apparatuses have been proposed where the effect of exercise is brought out through passive exercise, in which the user does not exert muscle power voluntarily, but instead, an external force acts on the user causing the muscles of the user to stretch and contract. Examples of apparatuses proposed for exercising the legs, with the user standing up, include apparatuses that mimic a walking exercise and that are directed at walking training and/or at preventing osteoarthritis of the knee (for instance, Patent Document 1 and Patent Document 2).

In the training apparatus disclosed in Patent Document 1, a pair of steps, on which the left and right feet are respectively placed, are imparted a motion that combines front, rear, left and right linear reciprocating movement, as a result of which the user is caused to execute a pseudo-skating motion, and wherein the phase difference between the left and right steps in a front-rear motion, and the phase difference between the left and right steps in a left-right motion, can be set within a range from 0 degrees to 360 degrees. The phase difference is 180 degrees immediately after startup, and is then modified to lengthen the period over which the left and right feet move in the same front-rear direction. A driving device causes each step to execute the above-described motion. Therefore, the user, whose left and right feet stand on the steps, does not have to exercise voluntarily or actively. Instead, the legs perform passive exercise accompanying the movement of the steps.

In the walk experiencing apparatus disclosed in Patent Document 2, a pair of left and right walk plates are driven by a walk-plate horizontally driving device, and are also swung in the front-rear direction in order to modify the height position of the feet and/or the inclination angle of the soles. The walk plates can also be swung to the left and right in order to modify the orientation of the feet.

Patent Document 1: JP 2003-290386 A

Patent Document 2: JP 10-55131 A

### PROBLEMS TO BE SOLVED BY THE INVENTION

The apparatus disclosed in Patent Document 1 envisages muscle training focusing on the rectus femoris muscle and the hamstrings, on the basis of a skating motion in which the position of the feet and the position of the center of mass are offset from each other. Therefore, the inclination angle of the steps is made freely modifiable by supporting the steps on a gimbal, in order to stretch and contract the muscles of the lower leg, such as the gastrocnemius muscle and the soleus muscle. Accordingly, stable exercise cannot be achieved if the legs of the user have little muscle strength in use. Moreover, the knees are ordinarily subjected to a significant load during a skating motion, and hence the apparatus may be no longer usable in case of knee pain, even though the apparatus enables exercise for preventing osteoarthritis of the knee.

The apparatus disclosed in Patent Document 2 envisages a simulated walking motion in which the leg muscles are stretched and contracted in the same way as during walking. The apparatus is thus desirable in terms of promoting vein circulation. However, the load on knee joints is comparable to that during walking, and hence the apparatus may become unusable by a user suffering from knee pain.

An apparatus would thus be highly desirable that could prompt stretching and contraction of the lower leg muscles and stimulate circulation in the veins of the legs, without causing any knee pain, in particular for purposes of rehabilitation. To meet that demand, it has been proposed to narrow the motion allowable range of steps, or to set the direction of allowable motion of the steps to a direction in which the load on the knees is lessened, to impart thereby so-called passive exercise alone to the legs of the user.

Enabling only passive exercise is problematic in that the user cannot perform also active exercise when he/she desires to do so. Of course, the motion allowable range of the steps and/or the directions of allowable motion of the steps can be made adjustable, to enable the user to perform also active exercise. In this case, however, a user that wishes to perform only passive exercise may end up exercising at an expanded motion allowable range, which in some cases may impose a significant burden on the user.

In the light of the above, it is an object of the present invention to provide an exercise aiding apparatus that allows increasing the amount of exercise performed by the user, by expanding a step motion allowable range according to the volition of the user.

### MEANS FOR SOLVING THE PROBLEM

The present invention has: a step on which user's foot can be placed; a step driving means for causing the step to move, and causing thereby the foot placed on the step to exercise; and a motion allowable zone modifying means for expanding a motion allowable range of the step established by the step driving means in accordance with a load acting on the step.

The step driving means causes a pair of left and right steps, on which the user's left and right feet are respectively placed, to slide reciprocally. As the motion allowable zone modifying means there can be used means for expanding the reciprocating sliding range of the steps. In addition, the step driving means causes the foot placed on the step to execute plantar and dorsal flexion motions, by changing a height positional relationship between a front end side and a rear end side of the step. As the motion allowable zone modifying means there can be used means for expanding the range of change of the height positional relationship between the front end side and the rear end side of the step. Further, the step driving means may cause a pair of left and right steps, on which the user's left and right feet can be respectively placed, to slide reciprocally, and may cause the feet placed on the steps to execute plantar and dorsal flexion motions, by changing a height positional relationship between a front end side and a rear end side of the steps; and the motion allowable zone modifying means may expand at least one range from among a reciprocating sliding range of the steps and a range of change of a height positional relationship between a front end side and a rear end side of the steps.

Preferably, the step is turnably mounted, by way of a rotary shaft, on a slide unit that is slidably supported; the step driving means has a reciprocating motion imparting member and a driven member coupled to the step, said step driving means being configured that the driven member, which receives a reciprocating motion by the reciprocating motion imparting member and which transmits the reciprocating motion to the step, causes the step to turn about the rotary shaft thereof. In particular, there may be suitably used, as the step driving means, step driving means formed of a link, one end of which is coupled to the step, and the other end of which is turnably coupled to a fixed point, and the reciprocating motion imparting member that causes the link to turn reciprocally, said step driving means being configured that the step is caused to execute a reciprocating motion in the slide direction, and the height of a coupling point between the step and the link is modified, due to turning of the link by the reciprocating motion imparting member. In this case, there may be used, as the motion allowable zone modifying means, means for making the length of the link variable.

The step may be turnably mounted, by way of a rotary shaft, on a slide unit that is slidably supported; the step driving means may be formed of a reciprocating motion imparting member and a cam mechanism that is coupled to the step and that transmits, to the step, a reciprocating motion by the reciprocating motion imparting member, said step driving means being configured that the cam mechanism modifies the height of a coupling point with the step in response to a reciprocating motion, in the slide direction, by the reciprocating motion imparting member.

In a case where the reciprocating motion imparting member is a crank mechanism, the motion allowable zone modifying means may be provided making the length of a connecting rod in the crank mechanism variable.

Preferably, there is provided a load detection means for detecting a load acting on the step; and a control means for causing the motion allowable zone modifying means to enlarge the motion allowable zone when a load value, detected by the load detection means and varying in accordance with the motion of the step by the step driving means, exceeds a threshold value over a number of consecutive times.

Preferably, there is provided a display means for displaying that the motion allowable zone modifying means has enlarged the motion allowable zone. In addition, there is preferably provided a base stand, on the top face of which the step is disposed, and inside which the step driving means is disposed, and the step is positioned, over the entire motion allowable range thereof, higher than the top face of the base stand at all times.

In the exercise aiding apparatus of the present invention, the step motion allowable range is expanded when the user standing on the step exerts a force on the foot, whereupon the load acting on the step is increased, even if the step driving means drives the step by imparting only passive exercise to the foot placed on the step. As a result, the user can perform also active exercise (autonomous exercise), in addition to passive exercise, without any safety problems.

The step driving means may cause a pair of left and right steps, on which the user's left and right feet can be respectively placed, to slide reciprocally, and the motion allowable zone modifying means may expand the reciprocating sliding range of the steps. It becomes then possible to stretch and contract the muscles of the thighs as well as the lower legs through sliding of the steps, and to increase the load acting on the muscles, thanks to the expanded motion allowable range of the sliding motion that results from the increased load placed on the steps.

The step driving means may cause the foot placed on the step to execute plantar and dorsal flexion motions, by changing a height positional relationship between a front end side and a rear end side of the step, and the motion allowable zone modifying means may expand the range of change of the height positional relationship between the front end side and the rear end side of the step. It becomes then possible to impart a plantar flexion and dorsal flexion movement to the ankle joint, and to expand the motion allowable range of the ankle joint, because plantar flexion and dorsal flexion is further prompted by increasing the load placed on the step.

The above two effects can be elicited simultaneously when the step driving means and the motion allowable zone modifying means have the above-described two configurations.

Further, the step may be turnably mounted, by way of a rotary shaft, on a slide unit that is slidably supported; the step driving means may be formed of a reciprocating motion imparting member and a driven member coupled to the step, said step driving means being configured that the driven member, which receives a reciprocating motion by the reciprocating motion imparting member and which transmits the reciprocating motion to the step, causes the step to turn about the rotary shaft thereof. It becomes then possible to realize a simple mechanism for imparting, to the step, a sliding motion and a motion whereby the ankle joint is caused to execute plantar and dorsal flexion motions.

In particular, the step may be turnably mounted, by way of a rotary shaft, on a slide unit that is slidably supported; and the step driving means may be formed of a link, one end of which is coupled to the step and the other end of which is turnably coupled to a fixed point, and the reciprocating motion imparting member that causes the link to turn reciprocally, said step driving means being configured that the step is caused to execute a reciprocating motion in the slide direction, and the height of a coupling point between the step and the link is modified, due to turning of the link by the reciprocating motion imparting member. It becomes then possible to realize a simple mechanism for imparting, to the step, a sliding motion and a motion whereby the ankle joint is caused to execute plantar and dorsal flexion motions. Herein, the step motion allowable range can be easily expanded, in accordance with the load acting on the step, if the motion allowable zone modifying means is provided making the length of the link variable.

The step may be turnably mounted, by way of a rotary shaft, on a slide unit that is slidably supported; the step driving means may have a reciprocating motion imparting member that reciprocally drives the step in the slide direction, and a cam mechanism, coupled to the step, and that raises and lowers a coupling point with the step accompanying the sliding of the step, said step driving means being configured that the cam mechanism modifies the height of a coupling point with the step in response to a reciprocating motion, in the slide direction, by the reciprocating motion imparting member. It becomes then possible to realize a simple mechanism for imparting, to the step, a sliding motion and a motion whereby the ankle joint is caused to execute plantar and dorsal flexion motions.

The step motion allowable range can be easily expanded in accordance with the load acting on the step also in a case where the reciprocating motion imparting member is a crank mechanism, and the motion allowable zone modifying means is provided making the length of a connecting rod in the crank mechanism variable.

The concern that the step motion allowable zone might be enlarged on account of an unintentional movement by the user can be allayed, and yet higher safety can be achieved as a result, in an exercise aiding apparatus provided with a load detection means for detecting a load acting on the step; and a control means for causing the motion allowable zone modifying means to enlarge the motion allowable zone when a load value, detected by the load detection means and varying in accordance with the motion of the step by the step driving means, exceeds a threshold value over a number of consecutive times.

Whether the step motion allowable zone has been expanded or not by the motion allowable zone modifying means can be easily checked, by providing a display means for displaying that the motion allowable zone modifying means has enlarged the motion allowable zone.

Herein there may be provided also a base stand on the top face whereof the step is disposed, and inside which the step driving means is disposed, wherein the step is positioned, at all times and over the entire motion allowable range thereof, higher than the top face of the base stand. It becomes then possible to prevent the foot from becoming wedged between the step and the base stand, even if the foot comes off the step.

### BRIEF DESCRIPTION OF THE DRAWINGS

FIG. 1 is a perspective-view diagram illustrating the appearance of an example of an embodiment of the present invention;

FIG. 2 is a transparent plain-view diagram illustrating steps and step driving means in the embodiment;

FIG. 3 is an explanatory diagram illustrating the operation of the step driving means;

FIG. 4A is a schematic cross-sectional diagram of a link in the embodiment;

FIG. 4B is a schematic cross-sectional diagram of another example of the link;

FIG. 5 is a time chart of the output voltage of a load detection means in the embodiment;

FIG. 6 is a flowchart of an operation relating an explanation of a motion allowable range in the embodiment;

FIGS. 7A-7D are explanatory diagrams illustrating the operation of another example of the step driving means;

FIG. 8 is a partial cross-sectional diagram of the embodiment.

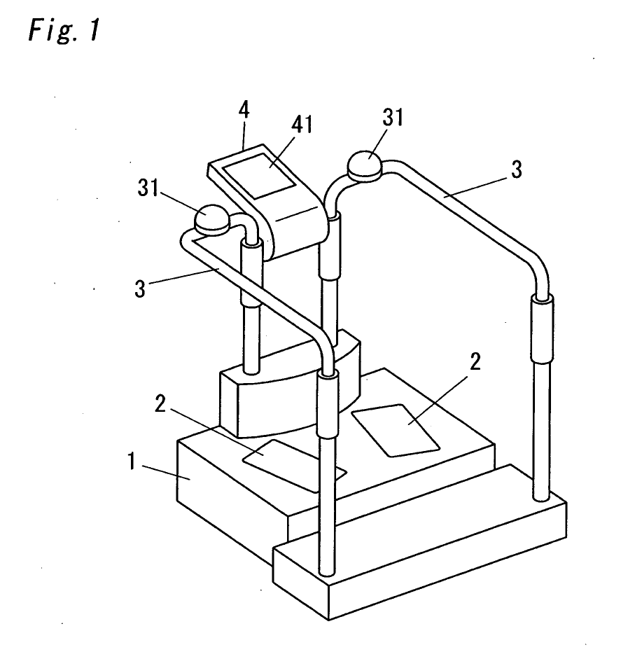

### EXPLANATION OF REFERENCE NUMERALS

1 base stand

2 step

3 handrail

4 operation panel

5 step driving means

### BEST MODE FOR CARRYING OUT THE INVENTION

The present invention will be explained on the basis of an embodiment illustrated in accompanying drawings. An exercise aiding apparatus illustrated in the figures comprises a base stand 1 on the top face whereof there is disposed a pair of left and right steps 2, 2; left and right handrails 3, 3 that rise from the base stand 1; an operation panel 4 disposed, by use of the handrails 3, 3, at the front side of the base stand 1; and a step driving means 5, disposed inside the base stand 1, that drives the steps 2, 2. The user grips the left and right handrails b, 3 and stands with the left and right feet placed on each step 2, 2. In that state, the step driving means 5 is operated to cause the steps 2, 2 to move, as a result of which the legs of the user are exercised passively.

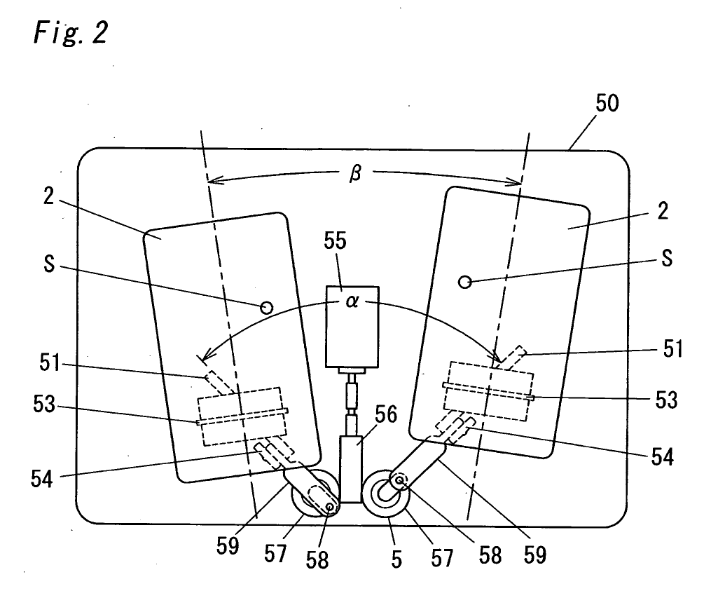

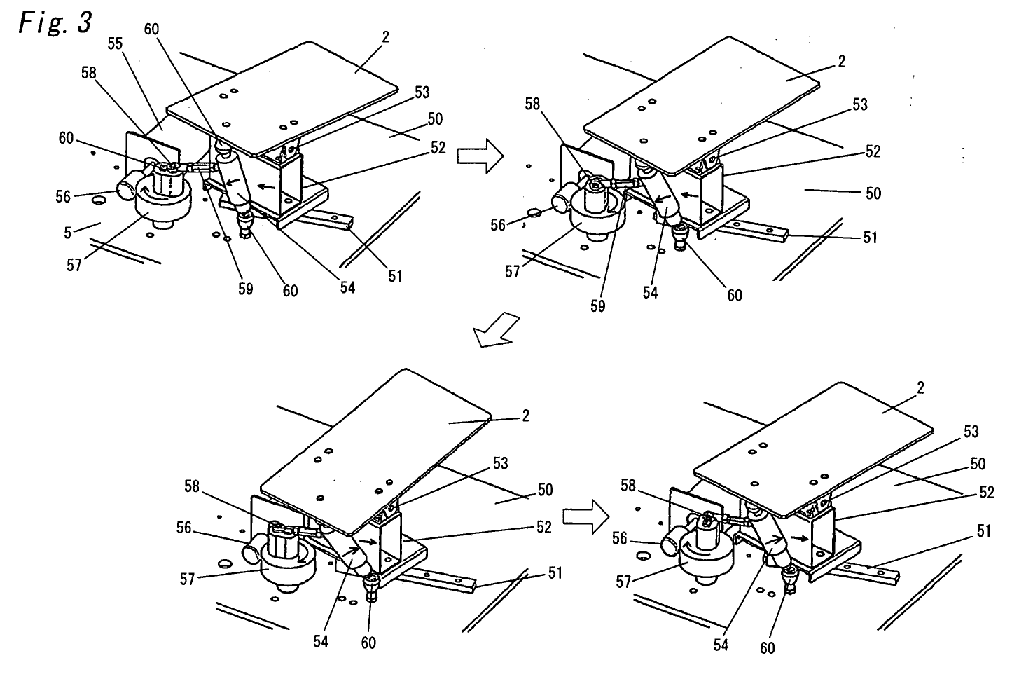

The steps 2, 2 are dimensioned so as to allow the entire soles of the user's feet to be placed thereon. A material and/or shape having a large coefficient of friction is used in the top face of the steps 2, 2. The height positional relationship of the rear end side and the front end side of the steps 2 is changed in response to the reciprocating sliding motion by the step driving means 5 in the front, rear, left and right directions. As a result, the user's feet, placed on the steps 2, are repeatedly caused to execute a plantar flexion motion, in which the toe side descends, and a dorsal flexion motion, in which the toe side rises. FIG. 2 and FIG. 3 illustrate the step driving means 5 that produces the above movement of the steps 2, 2.

In addition to imparting front, rear, left and right sliding motion to the steps 2, the step driving means 5 illustrated herein operates to change the height positional relationship between the front end side and the rear end side of the steps 2. Guide rails 51, 51 are fixed, to the left and right portions of the top face of the base plate 50 (or a bottom plate of the base stand 1). A slide block 52, comprising in the bottom thereof a slider section that can slide along the guide rails 51, is mounted on each of the guide rails 51. A rotation shaft 53 is provided on the top face side of each slide block 52. The plate-like steps 2 are turnably supported about the rotation shafts 53 by the rotation shaft 53. One end (rear end) of each step 2, 2 is coupled to the base plate 50 via a link 54. Universal joints 60, 60 are respectively provided at each coupling section between one end of each link 54 and the base plate 50, and between the other end of each link 54 and each step 2.

Between the left and right slide blocks 52, 52 of the base plate 50 there is disposed a driving motor 55 the output shaft whereof is provided with a worm 56. A pair of worm wheels 57, 57 is disposed at the left and right of the worm 56. The worm wheels 57, 57 mesh with the worm 56 and comprise each a respective eccentric shaft 58, 58. Each eccentric shaft 58 is coupled via a connecting rod 59 to the link 54. The link 54 and the worm wheel 57 provided with the eccentric shaft 58 are positioned spaced apart from each other in the longitudinal direction of the guide rails 51. Respective universal joints 60, 60 are also provided at a coupling section between the eccentric shaft 58 and one end of the connecting rod 59 that joins the link 54 and the worm wheel 57, and at a coupling section between each link 54 and the other end of the connecting rod 59.

When the eccentric shaft 58 is caused to rotate by the motor 55, via the worm 56 and the worm wheel 57, the connecting rod 59 that makes up a crank mechanism together with the eccentric shaft 58 causes the link 54 to perform a rocking motion about the universal joint 60 provided at the base plate 50 side of the link 54. The slide blocks 52, 52 and the steps 2 perform a reciprocating sliding motion in the direction along the guide rails 51, on account of the motion of the components of the rocking motion that coincide with the longitudinal direction of the guide rails 51.

In the example illustrated in the figures, the left and right guide rails 51, 51 are not disposed parallel to each other. Instead, the left and right guide rails 51, 51 are provided in the base plate 510 in such a manner that the spacing between the guide rails 51, 51 at the front end side thereof (position of the toe side when the feet are placed on the steps 2) is wider than the spacing at the rear end side. The steps 2 and the slide blocks 52 that are mounted on respective guide rails 51, 51, disposed in a V-shaped arrangement, move in such a manner so as to spread sideways when moving forward.

The opening angle a of the two guide rails 51, 51 disposed in a V-shaped arrangement in the example of the figure is set to range from about 90° to 135°, to prevent excessive shear forces from acting on the knees when the steps 2 are caused to move with the feet placed thereon. Preferably, the opening angle a is modifiable by making it possible for the base plate 50 to move with respect to the base stand 1.

The rocking motion of the links 54 causes the coupling sections between the links 54 and the steps 2 to move up and down, in response to which the steps 2 turn about the rotation shafts 53. The eccentric shafts 58 and the links 54 are coupled via the connecting rods 59 in such a manner that, at halfway during the stroke of the sliding motion, the steps 2 take on a horizontal attitude, at one end of the stroke, the rear end side of the steps 2, to which the links 54 are connected, is raised up, and at the other end of the stroke the rear end side of the steps 2 descends.

As a result, the steps 2 perform also a turning motion whereby the toe side descends when the steps 2 move forward, and the heel side descends when the steps 2 move rearwards, simultaneously with the sliding motion of the steps 2 along the guide rails 51.

As FIG. 2 shows, the rotation shafts 53, about which the steps 2 turn, are respectively provided along directions perpendicular to the longitudinal direction of the steps 2, at positions closer to the rear end of the steps 2 than the longitudinal direction center thereof. The rotation shafts 53 are also positioned in such a manner that the axial direction of each rotation shaft 53 is not perpendicular to the longitudinal direction of the respective guide rail 51, so that the front end side (toe side) of the steps 2 bears further inward than the guide rails 51.

The spacing between the two steps 2, 2 is wider at the front end side than at the rear end side thereof. This opening angle β is set to range from 10 to 30°. Therefore, the user can place the feet on both steps 2, 2 while standing up with the leg muscles in a relaxed state.

Driving of the left and right steps 2, 2 by the step driving means 5 is set in such a manner so as to shift the positions of the eccentric shafts 58 that are provided in the pair of worm wheels 57, 57 that mesh with the worm 56, so that, as a result the step 2 on the left foot side retreats when the step 2 on the right foot side moves forward, and the step 2 on the right foot side retreats when the step 2 of the left foot side moves forward, i.e. in such a manner that the steps move in opposite phase to each other. The movement of both steps 2, 2 is synchronized at all times since motive power is distributed to the left and right by the two worm wheels 57, 57 that mesh with the worm 56.

To exercise using the exercise aiding apparatus having the above configuration, the user stands, with the left foot and the right foot placed on the left and right steps 2, 2, while gripping the handrails 3, and switches on an operation switch disposed in the operation panel 4. The step driving means 5 is operated as a result, whereupon the left and right steps 2, 2 perform a reverse-phase motion to the front, rear, left and right, as described above, and perform a turning motion which the front end side descends during advance and the rear end side descends during retreat.

The user, whose feet are placed on the steps 2, 2, moves as a result the feet to the front and rear, and to the left and right, accompanying the motion of the steps 2, while plantar flexion and dorsal flexion are exerted on the ankle joints through the turning of the steps 2. The center of gravity of the user standing on the steps 2, 2 shifts, in the front-rear direction, only slightly, since the left and right steps 2, 2 move to the front, rear, left and right with a 180° phase difference. Hence, the user almost never loses balance due to the motion of the steps 2, even if the user has an impaired balance function.

The change in the foot position as a result of the opposite-phase motion of each step 2, 2 in the front, rear, left and right directions is a position change similar to that of walking exercise. Accordingly, at least the muscles of the lower legs stretch and contract in the same way as during walking. At the rear end position in the front-rear motion, the foot position stands further rearwards than the center of mass of the user. At the end position, therefore, the muscles from the rear of the thighs to the buttock can be tensed up.

In ordinary walking exercise, the foot position moves mainly in the front-rear direction. However, the trunk of the user twists when this movement is compounded with movement to the left and right, as compared with front-rear movement or left-right movement alone. As a result, it becomes possible to stimulate the internal organs, while the balance of the user is upset more actively in multiple directions. Hence, more muscles of the lower leg and thighs (such as adductor muscle, rectus femoris muscle, vastus medialis, vastus lateralis, biceps femoris muscle, musculus semitendinosus, and musculus semimembranosus) can be stimulated. Sugar uptake by the muscles increases as a result, even though the exercise is a light-load passive exercise. The exercise can thus potentially elicit an improving effect on type-2 diabetes.

The Achilles tendon is stretched during the above-mentioned dorsal flexion. The motion allowable range of the ankles can be increased thereby. Also, hallux valgus can be abated because the force acts on the toes during plantar flexion. Repeated plantar flexion and dorsal flexion allow stretching and contracting the lower leg muscles, mainly the gastrocnemius muscle and the soleus muscle. Stretching and contraction of these muscles increases circulation in the leg veins, and allows eliminating swelling in the legs.

As is evident from the above-described configuration of the step driving means 5, the phase difference of the front, rear, left and right sliding motion of the left and right steps 2, 2 is determined by the positions of the eccentric shafts 58 provided in the worm wheels 57, i.e. is determined by the meshing position of the worm wheels 57 and the worm 56. Accordingly, modifying this meshing position allows setting an arbitrary phase difference, and allows both steps 2, 2 to move in-phase easily. The center of mass of the user moves frontward and rearward during in-phase motion. Therefore, not only just the leg muscles are exercised, but also, for instance, the dorsolumbar region can be exercised in order to keep the balance.

Passive exercise can be carried out while the handrails 3 are gripped. Therefore, the user does not fall or the like even upon loss of balance. In the example of the figure, nonetheless, emergency stop switches 31 that stop the action of the step driving means 5 are provided on the handrails 3, to increase safety in case of loss of balance, in such a manner that should any accident occur, the hands that grip the handrail 3 can easily push the emergency stop switches 31.

Load detection means S comprising, for instance, pressure sensors, is disposed in the steps 2. The step driving means 5 may be stopped when the load detection means S do not detect any weight at a time when the steps 2 are being moved by the step driving means 5. This way, the motion can be stopped automatically in case that feet come off the steps 2 due to loss of balance.

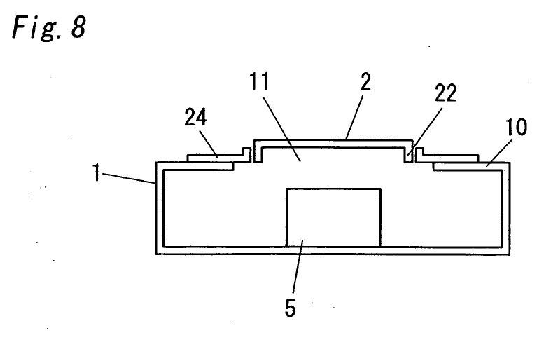

As illustrated in FIG. 8, an opening 11 is provided in a top plate 10 of the base stand 1 inside which the step driving means 5 is housed. The steps 2, positioned higher than the top plate 10, and the step driving means 5, disposed inside the base stand 1, are coupled in the opening 11. The steps 2 are disposed at a height such that the entirety of the steps 2 is positioned higher than the top plate 10 at all times and over the entire range (including a below-described expansion region) within which the steps 2 turn about the rotation shafts 53.

Thus, the feet placed on the steps 2 do not get wedged between the steps 2 and the top plate 10, even if the feet come off the area of the top face of the steps 2. As illustrated in FIG. 8, there may also be provided a skirt portion 22 at the outer edge of each step 2, as well as a slide cover 24 that surrounds each step 2 and that slides over the top plate 10 accompanying the front, rear, left and right motion of the step 2, thanks to which the apparatus can be used yet more safely. Shifting of the position of the feet may also be prevented by providing, on the steps 2, a foot fixing means, such as a strap or the like, for fixing the feet.

In the driving of the steps 2 using the step driving means 5, the turning range (turning angle) about the rotation shafts 53 of the steps 2 and the slide range of the steps 2 are determined by the eccentricity of the eccentric shafts 58 in the reciprocating motion imparting means comprising the crank mechanisms that comprise the eccentric shafts 58 and the connecting rods 59; by the length of the links 54; and by the coupling positions of the links 54 and the connecting rods 59. However, both the slide range and the turning range of the steps 2 are expanded if the steps 2 are stepped on more strongly accompanying the turning of the steps 2.

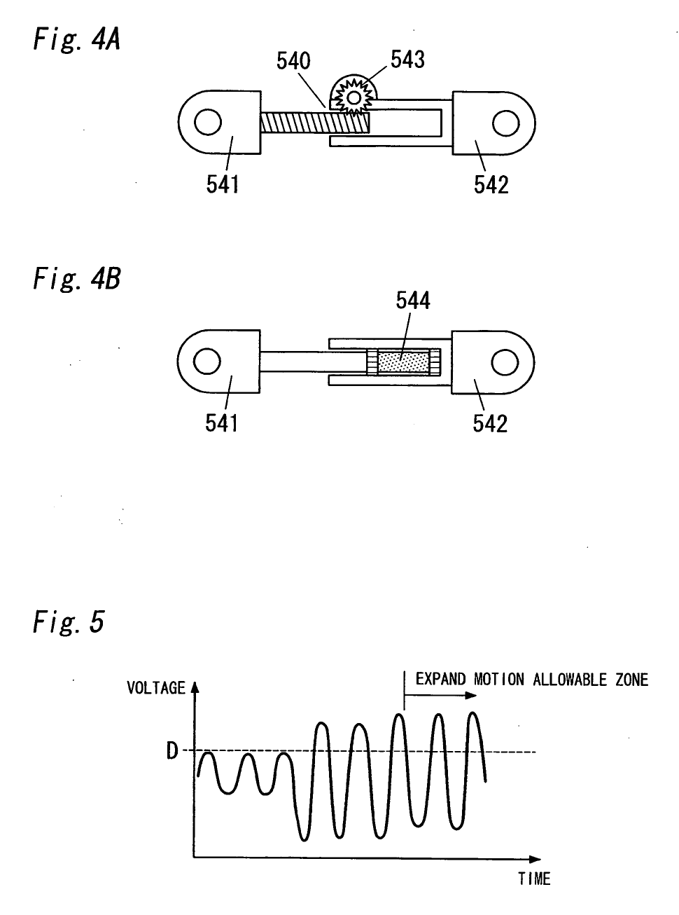

This expansion is realized by making the length of the links 54 freely adjustable. To carry out this length adjustment, each link 54 may comprise, for instance, two members 541, 542 coupled by a rack and pinion mechanism 540 such as the one illustrated in FIG. 4, so that the length is modified through rotation of the pinion by a motor 543. Instead of the rack and pinion mechanism there may be used a mechanism comprising a screw shaft onto which a nut is screwed. There may also be used a solenoid, or an actuator 544 in which an electrostrictive polymer, which stretches when voltage is applied thereon, is coiled in a tubular shape. Any mechanism may be resorted to, so long as the above length can be modified.

Normally, the links 54 remain in a shortened state. However, the links 54 are lengthened when the load acting on the steps 2 increases through the force that the user exerts on the steps 2 when stepping on the steps 2. Both the rotation range and the slide range of the steps 2 are expanded as a result.

Herein, the load acting on the steps 2 is detected by the above-described load detection devices S. A control circuit that performs control (i.e. control of the motor 543) for expanding the motion allowable zone of the steps 2, and that performs driving control of the step driving means 5, drives the motor 543 to increase the length of the links 54 if a load value (voltage value) detected by the load detection devices S exceeds a threshold value D that is set in accordance with the weight of the user, and to restore the length of the links 54 to an original length if the detected load value does not exceed the threshold value D.

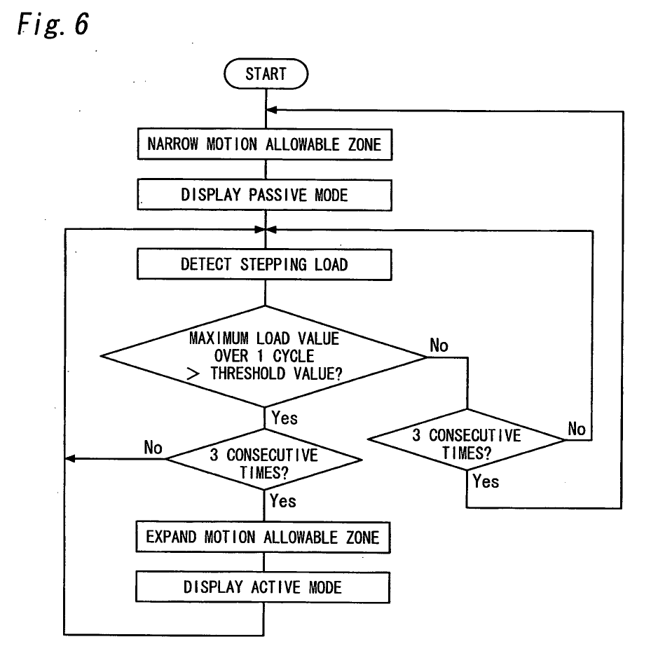

The load detected by the load detection devices S varies in response to the motion, particularly to the rotation, of the steps 2, as illustrated in FIG. 5. Therefore, control is performed in such a manner that the length of the links 54 is increased if the maximum value of an a load value in one change cycle accompanying the turning of the steps 2 exceeds the threshold value D over a number of consecutive times, and in such a manner that the length of the links 54 is shortened if the maximum value does not exceed the threshold value D over a number of consecutive times. Also, the expansion of the motion allowable range of the steps 2 is displayed on a display unit 41 of the operation panel 4. The load value fluctuates due to the movement of the user. Therefore, a plurality of consecutive times is set as a condition, to prevent thereby occurrences where the motion allowable range is expanded inadvertently. FIG. 6 illustrates a flowchart of the above control.

Preferably, as illustrated in FIG. 6, a passive mode is displayed on the display unit 41 when the links 54 are short, i.e. when only passive exercise is being carried out, and an active mode is displayed when the links 54 are lengthened through the action of a load on the steps 2.

The motion allowable range of the feet expands, both for sliding motion and plantar and dorsal flexion, when the user strongly steps on the steps 2 over a number of times. That is, a passive exercise state, in which the feet move along with the movement of the steps 2, can be switched to exercise (active exercise), in which the user actively moves the feet, according to the user's intent.

In the above example, the motion allowable zone modifying means, which expands the motion allowable range of the steps 2 in accordance with the load that is exerted on the steps 2, is formed by the variable-length links 54. However, the motion allowable zone modifying means can be realized by configuring the connecting rods 59 in the crank mechanism to be of variable length, as in the case of the links 54. In the example of the figure, as well there can be augmented, the slide range of the steps 2, as well as the turning range of the steps 2 in the direction in which the toes descend, according to the increases in the length of the connecting rods 59.

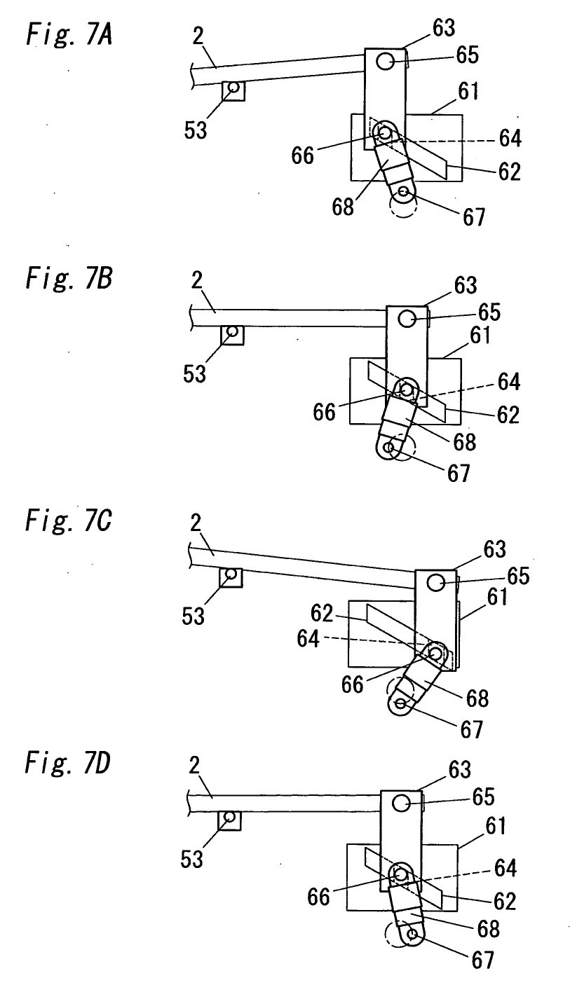

FIGS. 7A-7D illustrate another example of the step driving means 5. Herein, a cam plate 61 and a coupling plate 63 are used instead of each link 54 in the example above. The cam plate 61, fixed to the base plate 50, comprises a straight groove-like cam 62 extending along the front-rear direction and the up-and-down direction.

A coupling plate 63 comprises a rectangular cam follower 64 that is integral with the coupling plate 63 and that slidably moves along the oblique-groove cam 62, and a shaft 65 turnably coupled to the rear end portion of each step 2. The steps 2 are turnably supported via the rotation shafts 53 on the slidable slide blocks 52, as in the example above. To the coupling plate 63, one end of the connecting rod 68, whose other end is coupled to a rotatably driven eccentric shaft 67, is coupled by a shaft 66.

The connecting rod 68 causes the coupling plate 63 to move along the cam 62 when the eccentric shaft 67, disposed below the coupling plate 63, is rotated. The cam follower 64 is rectangular in shape and is fixed to the coupling arm 63, as described above. Therefore, the coupling arm 63 moves frontward and rearward at the same time that it moves up and down, while preserving the attitude illustrated in the figure.

As a result, the steps 2 move also frontward and rearward simultaneously with the up and down motion of the rear end side of the steps 2, which are the coupling point at which the steps 2 are coupled to the coupling arms 63. When the steps 2 move forward, the rear end side of the steps 2 rise up and the front end side (toe side) of the steps 2 descends. When the steps 2 move backwards, the rear end side of the steps 2 descends, and the front end side (toe side) rises. In this example as well, the slide direction of the steps 2 need not be in a non-perpendicular relationship with respect to the axial direction of the rotation shafts 53.

The slide range can be increased by using the same configuration, illustrated in FIG. 4, for the connecting rod 68 in a crank mechanism that comprises the connecting rod 68 and the eccentric shaft 58, in the same way as in the example above. Also, the turning range can be increased by configuring the cam 62 to have a length according to an expanded slide range, and by configuring a shape of the cam 62 such that the expansion region of the cam 62 expands the turning range of the steps 2.

In the example explained first, where the links 54 are used, the connecting rods 59 may be coupled to the slide blocks 52, instead of to the links 54. In this case, one end of each link 54 is mounted to the base plate 50, via a shaft, in such a manner that the links 54 turn only in one direction parallel to the slide direction of the steps 2, as restricted by the guide rails 51. When the steps 2 slide together with the slide blocks 52, the links 54 that couple the base plate 50 and the steps 2 turn about the end of the link 54 at the base plate 50 side. The steps 2 are caused to turn through changes in the height of the connection point between the links 54 and the steps 2. In this example, however, the expansion in the motion allowable range of the steps 2 acts only on the slide range when it is the length of the connecting rods 59 that is variable, while, acts only on the turning range when it is the length of the links 54 that is variable.

1. An exercise aiding apparatus, comprising:
a step on which user's foot can be placed;
a step driving means for causing the step to move, and causing thereby the foot placed on the step to exercise; and
a motion allowable zone modifying means for expanding a motion allowable range of the step established by the step driving means in accordance with a load acting on the step.

2. The exercise aiding apparatus according to claim 1,
wherein the step driving means causes a pair of left and right steps, on which the user's left and right feet are respectively placed, to slide reciprocally, and
wherein the motion allowable zone modifying means expands a reciprocating sliding range of the steps.

3. The exercise aiding apparatus according to claim 1,
wherein the step driving means causes the foot placed on the step to execute plantar and dorsal flexion motions, by changing a height positional relationship between a front end side and a rear end side of the step, and
wherein the motion allowable zone modifying means expands a range of change of the height positional relationship between the front end side and the rear end side of the step.

4. The exercise aiding apparatus according to claim 1,
wherein the step driving means causes a pair of left and right steps, on which the user's left and right feet can be respectively placed, to slide reciprocally, and causes the feet placed on the steps to execute plantar and dorsal flexion motions, by changing a height positional relationship between a front end side and a rear end side of the steps, and
wherein the motion allowable zone modifying means expands at least one range from among a reciprocating sliding range of the steps and a range of change of a height positional relationship between a front end side and a rear end side of the steps.

5. The exercise aiding apparatus according to claim 1,
wherein the step is turnably mounted, by way of a rotary shaft, on a slide unit that is slidably supported, and
wherein the step driving means is formed of a reciprocating motion imparting member and a driven member coupled to the step, said step driving means being configured that the driven member, which receives a reciprocating motion by the reciprocating motion imparting member and which transmits the reciprocating motion to the step, causes the step to turn about the rotary shaft thereof.

6. The exercise aiding apparatus according to claim 4,
wherein the step is turnably mounted, by way of a rotary shaft, on a slide unit that is slidably supported, and
wherein the step driving means is formed of a link, one end of which is coupled to the step and the other end of which is turnably coupled to a fixed point, and a reciprocating motion imparting member that causes the link to turn reciprocally, said step driving means being configured that the step is caused to execute a reciprocating motion in the slide direction, and the height of a coupling point between the step and the link is modified, due to turning of the link by the reciprocating motion imparting member.

7. The exercise aiding apparatus according to claim 4,
wherein the step is turnably mounted, by way of a rotary shaft, on a slide unit that is slidably supported, and
wherein the step driving means is formed of a reciprocating motion imparting member and a cam mechanism that is coupled to the step and that transmits, to the step, a reciprocating motion by the reciprocating motion imparting member, said step driving means being configured that the cam mechanism modifies the height of a coupling point with the step in response to a reciprocating motion, in the slide direction, by the reciprocating motion imparting member.

8. The exercise aiding apparatus according to claim 6, wherein the motion allowable zone modifying means is provided making the length of the link variable.

9. The exercise aiding apparatus according to claim 6,
wherein the reciprocating motion imparting member has a crank mechanism, and
wherein the motion allowable zone modifying means is provided making the length of a connecting rod in the crank mechanism variable.

10. The exercise aiding apparatus according to claim 1, comprising:
a load detection means for detecting a load acting on the step; and
a control means for causing the motion allowable zone modifying means to enlarge the motion allowable zone when a load value, detected by the load detection means and varying in accordance with the motion of the step by the step driving means, exceeds a threshold value over a number of consecutive times.

11. The exercise aiding apparatus according to claim 1, comprising a display means for displaying that the motion allowable zone modifying means has enlarged the motion allowable zone.

12. The exercise aiding apparatus according to claim 1, comprising a base stand, on the top face of which the step is disposed, and inside which the step driving means is disposed, wherein
the step is positioned, over the entire motion allowable range thereof, higher than the top face of the base stand at all times.

13. The exercise aiding apparatus according to claim 2,
wherein the step is turnably mounted, by way of a rotary shaft, on a slide unit that is slidably supported, and
wherein the step driving means is formed of a reciprocating motion imparting member and a driven member coupled to the step, said step driving means being configured that the driven member, which receives a reciprocating motion by the reciprocating motion imparting member and which transmits the reciprocating motion to the step, causes the step to turn about the rotary shaft thereof.

14. The exercise aiding apparatus according to claim 3,
wherein the step is turnably mounted, by way of a rotary shaft, on a slide unit that is slidably supported, and
wherein the step driving means is formed of a reciprocating motion imparting member and a driven member coupled to the step, said step driving means being configured that the driven member, which receives a reciprocating motion by the reciprocating motion imparting member and which transmits the reciprocating motion to the step, causes the step to turn about the rotary shaft thereof.

15. The exercise aiding apparatus according to claim 4,
wherein the step is turnably mounted, by way of a rotary shaft, on a slide unit that is slidably supported, and
wherein the step driving means is formed of a reciprocating motion imparting member and a driven member coupled to the step, said step driving means being configured that the driven member, which receives a reciprocating motion by the reciprocating motion imparting member and which transmits the reciprocating motion to the step, causes the step to turn about the rotary shaft thereof.

16. The exercise aiding apparatus according to claim 5,
wherein the step is turnably mounted, by way of a rotary shaft, on a slide unit that is slidably supported, and
wherein the step driving means is formed of a link, one end of which is coupled to the step and the other end of which is turnably coupled to a fixed point, and a reciprocating motion imparting member that causes the link to turn reciprocally, said step driving means being configured that the step is caused to execute a reciprocating motion in the slide direction, and the height of a coupling point between the step and the link is modified, due to turning of the link by the reciprocating motion imparting member.

17. The exercise aiding apparatus according to claim 5,
wherein the step is turnably mounted, by way of a rotary shaft, on a slide unit that is slidably supported, and
wherein the step driving means is formed of a reciprocating motion imparting member and a cam mechanism that is coupled to the step and that transmits, to the step, a reciprocating motion by the reciprocating motion imparting member, said step driving means being configured that the cam mechanism modifies the height of a coupling point with the step in response to a reciprocating motion, in the slide direction, by the reciprocating motion imparting member.

18. The exercise aiding apparatus according to claim 7,
wherein the reciprocating motion imparting member has a crank mechanism, and
wherein the motion allowable zone modifying means is provided making the length of a connecting rod in the crank mechanism variable.

19. The exercise aiding apparatus according to claim 2, comprising:
a load detection means for detecting a load acting on the step; and
a control means for causing the motion allowable zone modifying means to enlarge the motion allowable zone when a load value, detected by the load detection means and varying in accordance with the motion of the step by the step driving means, exceeds a threshold value over a number of consecutive times.

20. The exercise aiding apparatus according to claim 2, comprising a display means for displaying that the motion allowable zone modifying means has enlarged the motion allowable zone.
